(19) United States
(12) Patent Application Publication
(10) Pub. No.: US 2015/0210602 A1
(43) Pub. Date: Jul. 30, 2015

(54) ENHANCED PLANT GROWTH SYSTEM

(71) Applicants: Aicardo Roa-Espinosa, Madison, WI (US); Tomas James Roa-Lauby, Madison, WI (US)

(72) Inventors: Aicardo Roa-Espinosa, Madison, WI (US); Tomas James Roa-Lauby, Madison, WI (US)

(21) Appl. No.: 14/677,413

(22) Filed: Apr. 2, 2015

Related U.S. Application Data
(62) Division of application No. 13/956,235, filed on Jul. 31, 2013.

(51) Int. Cl. C05G 3/00; C05D 9/02; C05G 3/04; C05B 7/00

(52) U.S. Cl. CPC C05G 3/00; C05B 7/00; C05D 9/02; C05G 3/04

(57) ABSTRACT

A composition for enhancing plant growth and a method of applying the composition onto hydrophobic surfaces and retaining the composition on these surfaces is disclosed. The composition comprises a mixture of superabsorbent monomer and linear polymer that maybe partially cross-linked, a binder and nutrients that may be applied onto surfaces of materials that are part of the plants or plant growth environment such as seeds, soil, mulch, plant roots and herbicides. An aqueous solution of the composition may be applied to the material surfaces through the irrigation system. The polymer undergoes in-situ polymerization and crosslinking due to the effect of the heat from the sun and UV radiation. Once dried, a substantially solid film forms on the surfaces that contains the superabsorbent and the nutrients that are available for the plants to enhance their growth.

### RELATED APPLICATIONS

This application is a continuation in-part application claiming priority from U.S. application Ser. No. 13/046,675 filed on Mar. 11, 2011.

### FIELD OF THE INVENTION

The present invention generally relates to a composition and a method of applying the composition onto hydrophobic surfaces and retaining the composition on these surfaces. More specifically, the present invention relates to a composition and a method of applying the composition onto materials that impact plant growth such as plant seeds, soil, plant roots and mulch. The composition coats the material surfaces and helps lock in moisture and nutrients that are beneficial to plant growth.

### BACKGROUND OF THE INVENTION

Plant growth requires the presence of moisture and nutrients in the plants' environment such as planted seeds and the soil in which the seeds grow. In arid climates and in areas where rainfall and irrigation water are not sufficiently available, plant growth may suffer due to quick loss of moisture around the seeds. Conversely, excessive rain may cause soil erosion and wash away the fertilizers and nutrients in the soil and around the seeds. It would therefore be desirable to lock in moisture and nutrients into the environment in which the plant grows including the soil, plant seeds, plant roots, and mulch so that plant growth is enhanced especially in arid climates as well as climates that experience excessive rain.

A number of US patents disclose compositions for improving fiber absorbency and moisture as well as improving water retention of soil and other agricultural materials.

U.S. Pat. Nos. 6,686,414 and 6,984,419 relate to a cross-linked aqueous solution polymer composition consisting of at least one water soluble monomer, preferably an alpha, beta-ethylenically unsaturated carboxylic acid monomer and a crosslinking agent. The polymer solution is sufficiently low in viscosity such that it can be applied in an aqueous form, yet after crosslinking possesses a fast rate of acquisition and is high absorption capacity. The invention also relates to new methods of enhancing the absorbency of various articles, increasing the humectancy and/or absorbency of a fiber or fibrous matrix, improving the water retention of soil and other agricultural methods, and increasing the open time of cement by incorporating or applying an aqueous superabsorbent polymer composition.

U.S. Pat. No. 7,438,951 teaches a method of increasing the humectancy of a fiber, comprising: a) applying an aqueous polymer composition on a fiber, the composition comprising a polymer derived from monomers consisting of water soluble .alpha.-.beta.-ethylenically unsaturated carboxylic acid monomers neutralized with a base selected from the group consisting of alkali metal hydroxide, alkaline earth metal hydroxide, and combinations thereof and a crosslinking agent, and b) drying the composition.

U.S. Pat. No. 7,135,135 discloses a multilayer construction that includes a first layer that includes water sensitive thermoplastic polymer and a second layer disposed on the first layer containing a superabsorbent polymer.

While the composition provided in these prior art references can readily attach onto fibers having hydrophilic surfaces, the attachment resulting from the application of this composition onto substantially hydrophobic surfaces would appear to be weaker and therefore susceptible to loss and removal. Fibers having relatively hydrophilic surfaces may include wood fibers present in paper, disposable diapers and feminine hygiene products. Surfaces that are generally hydrophobic in the context of the present invention include soil, seeds, mulch and plant roots.

### SUMMARY OF THE PRESENT INVENTION

The composition of the present invention comprises at least one superabsorbent polymer for retaining moisture on the surfaces of materials onto which the composition is applied. The composition of the present invention further provides for at least one binder component and a nutrient component. The superabsorbent polymer of the present invention provides at least partial binding strength to hydrophobic material surfaces. The binder may further help attach the composition onto the hydrophobic surfaces of the materials in the environment of the plant in order to enhance plant growth. These materials may include seeds, ground soil, potting soil, plant roots, plant stems, herbicides, mulch made of untreated and treated saw mill residuals, mulch and biomass residuals from processing cotton, animal manure fibers, switch grass, burr plants, wheat, barley, oats, rye, triticale, sorghum, waste paper, hey and Sudan grass. The nutrient component serves as nourishment to the plant.

The application of the composition onto hydrophobic surfaces results in a film bonded to these surfaces. The film contains at least one superabsorbent polymer, at least one plant nutrient and optionally a binder. The superabsorbent polymer is slow to release any moisture it contains and quick to absorb moisture from rain or irrigation.

In one aspect of the present invention, a composition for applying and attaching chemicals that aid in plant growth onto substantially hydrophobic surfaces, the composition comprises: at least one partially cross-linked superabsorbent polymer for absorbing and retaining water, the superabsorbent polymer undergoing further in situ crosslinking through exposure to sunlight on the hydrophobic surfaces, the polymer being selected from a group consisting of polyacrylamide, polyacrylate and polyacrylamide/polyacrylate copolymers and combinations thereof; and at least one plant nutrient.

In another aspect of the present invention, a method of coating surfaces with a composition for enhancing plant growth, the method comprises: providing an aqueous solution containing at least one partially cross-linked superabsorbent polymer, a binder and at least one plant nutrient; providing materials in the plant growth environment, the materials having substantially hydrophobic surfaces; and applying the aqueous solution onto the surfaces of the materials; wherein applying the aqueous solution onto the surfaces of the materials exposes the partially cross-linked superabsorbent polymer to sunlight and to multiple cycles of water removal from drying by sunlight and rewetting from rainfall, wherein exposure of the partially cross-linked superabsorbent polymer to ultraviolet light from the sun enhances crosslinking of the polymer and enhances a water retention capacity of the polymer from a range of about 1 grams and about 4 grams of water per gram of dry cross-linked polymer to a range of about 10 grams and about 15 grams of water per gram of dry cross-linked polymer after a third cycle of drying, wherein drying the superabsorbent polymer forms a substantially solid film on the surfaces.

These and other features, aspects and advantages of the present invention will become better understood with reference to the following description and claims.

### DETAILED DESCRIPTION OF THE PRESENT INVENTION

The present invention provides a composition and a process for applying a composition onto plant components that enhances the growth of the plants. The composition comprises of at least one superabsorbent polymer, at least one plant nutrient and optionally a binder. The composition may be sprayed onto the plant components such as the stem, leaves, roots, seeds and fruit as well as materials that surround the plants such as ground soil, herbicides and mulch. Typically, water used in irrigation systems would contain the composition applied by spraying onto materials found in the plants' growth environment and onto the plant components.

Superabsorbent polymers are able to absorb and retain water in amounts that are many times the weight of the dry polymers. The superabsorbent polymers of the present invention include polyacrylamide, polyacrylate and polyacrylamide-polyacrylate copolymer in a cross-linked form. In this form, these polymers are substantially hydrophilic and swell when absorbing water while locking the water in with the polymer molecule. The bond between the polymer and much of the water tends to be fairly strong and only high pressure or heat applied to the polymers over a period of time removes some or much of the moisture locked in by the polymer. Depending on the polymer, its form (e.g., granule or film), size and purity, the water retention capacity may range from about 10 grams of water per gram of dry polymer to about 80 grams of water per gram of dry polymer. In the context of the present invention, the application of superabsorbent polymers onto plant components is beneficial to plant growth since the water locked in by the polymers is available to the plants for longer periods of time. This is especially helpful in arid climates that receive little rainfall that can quickly evaporate as dryness and heat resume after the rain; however plants in areas that see normal rainfall may also benefit from the increased moisture availability on their surfaces between periods of rainfall.

There are two main ways to polymerize and crosslink the polymers used in the present invention: 1) reacting the respective monomers with a crosslinking agent such as ammonium zirconium carbonate, and 2) exposure of the monomers to radiation such as beta, gamma or UV radiations. Heat may also induce low level crosslinking Depending on how crosslinking of the polymer is accomplished, the characteristics of the cross-linked polymer such as water retention capacity, adhesion properties and hardness of the dried polymer may vary. It would be desirable to achieve a high level of water retention for the cross-linked polymer as well as a high degree of adhesion to the plant component surfaces onto which the polymer solution is applied. To achieve a high level of water retention, it would be generally desirable to bring about a high level of crosslinking, but not excessively so, since a highly cross-linked polymer becomes hard and thus tends to have a high level of hydrophobicity, i.e. repel water. Also, a highly cross-linked polymer is structurally limited in its ability to swell.

In the process of the present invention, a solution containing a mixture of a monomer, linear polymer and partially cross-linked polymer is sprayed onto plant components and materials in the plant growth environment. The monomer may be either one of or a mixture of an acrylate salt and acrylamide. The linear and partially cross-linked polymers may be either one of or a mixture of polyacrylate, polyacrylamide or Sodium Acrylate Acrylamide copolymer. A portion of the polymer may be partially cross-linked at low levels simply from the exposure of the solution to above room temperatures for prolonged periods of time. This polymer mixture would be substantially soluble in water and, when dried to a film, exhibit low water retention of between about 1 grams of water per gram of dry polymer and about 4 grams of water per gram of dry polymer. The solution sprayed onto the plant components and materials dries when exposed to the sun to form a film that adheres to the plant surfaces. In the process, the UV light of the sun enhances the polymerization and crosslinking of the monomer and linear polymer fractions. In a subsequent rain fall, the polymer film becomes saturated with water causing the film to swell. Some of the water in the polymer is held tightly by the polymer, but the outer water layer is held more loosely and therefore available for use by the plant and its environment before the heat of the sun dries it. As may be envisioned, the polymer film is undergoing multiple cycles of drying and rewetting, all the while being exposed to UV light from the sun that causes the degree crosslinking to continually increase. At some point the polymer will be excessively cross-linked, typically after the third cycle of drying and rewetting. Some of the polymer adhered to the surfaces will also be washed off over time. When this occurs, a fresh solution mix may be sprayed onto the plant components and materials. Thus, for best results, an irrigation spray program for plants needs to take many variables into account to determine the best polymer, optimum polymer concentration and frequency of application.

The structures of the polymers of the present invention are shown below:

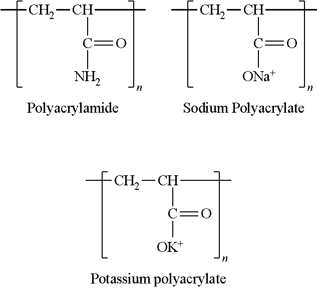

In an embodiment of the present invention, the polymer is sodium acrylate acrylamide copolymer. This polymer may be made from the reaction between an acrylamide monomer and an acrylic acid monomer as shown below.

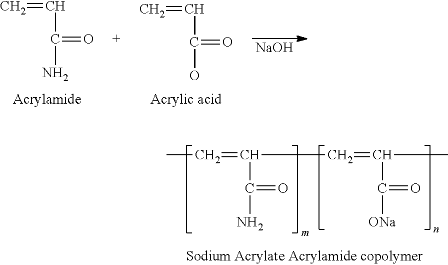

It has been empirically established that after the third cycle of exposure to the sun and drying followed by rewetting of the superabsorbents of the present invention, the superabsorbent film achieves its maximum water retention capacity of between 10 grams to about 15 grams of water per gram of dry polymer. After the third cycle, the superabsorbent polymers tend to become hard and lose their ability to absorb and retain water. While establishing the degree of crosslinking of a superabsorbent requires is a complex test, it is generally accepted in the art that water retention capacity is positively correlated with the level of crosslinking o the polymer but only to a degree; excessive crosslinking generally reduces water retention capacity.

Included in the embodiment of the present invention are binders to further help attach the superabsorbent polymers to the plant surfaces and materials. The preferred binders of the present invention comprise urea having a chemical formula of CO(NH₂)₂, pregelatinized starch and ethylenediamine having a chemical formula of C₂H₄(NH₂)₂. Also within the scope of the present invention are nutrients for nourishing the plants. The nutrients are present in the composition that is applied to the plants and are adapted to diffuse through the plant surfaces.

The nutrient component of the composition may comprise of mineral source nutrients and carbohydrate source nutrients.

Exemplary embodiments for the mineral source nutrient component of the composition may include urea compounds, anhydrous ammonia, nitrate salts, phosphate salts, ammonium salts and mixtures thereof. The cationic component of the nitrate salts that fall within the scope of the present invention may comprise of sodium, potassium or calcium for which the corresponding salt has a chemical formula of Ca(NO₃)₂.

Urea compounds that fall within the scope of the present invention include urea having a chemical formula of CO(NH₂)₂, urea sulfate CH₄N₂O.H₂O₄S, urea ammonium nitrate having a chemical formula of NH₄NO3+CO(NH₂)₂+H2O, urea ammonium phosphate CO(NH2)-NH3-H3PO4-H2O, and urea phosphate CO(NH₂)₂H₃PO₄.

Phosphate salts that fall within the scope of the present invention include ammonium chloride, ammonium nitrate, ammonium sulfate, Mono-ammonium phosphate, Diammonium phosphate, Ammonium phosphate-sulfate, Ammonium polyphosphate

The ammonium salt mineral source nutrients that fall within the context of the present invention include ammonium chloride NH₄Cl, ammonium nitrate NH₄NO₃, ammonium sulfate (NH₄)₂SO₄, mono-ammonium phosphate NH₄H₂PO₄, ammonium thiosulfate H₈N₂O₃S₂, diammonium phosphate (NH₄)₂HPO₄, ammonium phosphate-sulfate (NH₄)₂(H₂PO₄)(HSO₄) and ammonium polyphosphate (NH₄PO₃)ₙ.

Generally, the cationic component of the mineral source nutrients may include ammonium, calcium, urea, sodium, ferrous cation, ferric cation, manganese, copper, zinc and molybdenum. The complementary anionic components of the mineral source nutrients may include phosphate, sulfate, chloride, thiosulfate, carbonate, hydroxide, acetate, chelate, oxide, nitrate and sulfide. Additional mineral source nutrients that fall within the scope of the present invention include urea, ammonia, sulfur, citric acid, boric acid, oxalic acid, acetic acid, phosphoric acid and mixtures thereof.

The preferred carbohydrate source nutrient contains oligosaccharides. Examples of oligosaccharides that fall within the scope of the present invention include, but are not limited to, disaccharides, such as sucrose and lactose, trisaccharide raffinose and tetrasaccharide stachyose. The chemical formula of unmodified disaccharides is C₁₂H₂₂O₁₁.

Further, a small amount of crosslinking agent such as ammonium zirconium carbonate may be added to enhance the crosslinking rate of the polymer. Amounts in the range of between about 1% to about 2.5% of the ammonium zirconium carbonate may enhance the rate of crosslinking of polyacrylamide without hardening the polymer film too quickly.

A material that may play an important role in the plant growth environment with regard to preventing moisture loss is mulch. Fibers that undergo treatment to make them more hydrophilic especially benefit from the application of superabsorbent polymers onto their surfaces in the context of the present invention.

The method of preparation of the composition for coating the surfaces comprises the steps of:

1. Preparing an aqueous monomer solution at a concentration between about 10% to about 25%;

2. Raising the pH of the monomer to at least 7;

3. Optionally blending a crosslinking agent with the monomer solution at between about 1% to about 2% by weight of the active monomer solution;

4. Optionally, blending a binder with the monomer solution at between about 5% to about 15% by weight of the active monomer solution;

5. Blending in at least one mineral source nutrient component at between about 5 ppm to about 50 ppm by weight of the active monomer solution; and

6. Blending at least one carbohydrate source nutrient component at between about 5 ppm to about 50 ppm by weight of the active monomer solution.

The method for binding the composition onto hydrophobic surfaces comprises 1) applying an aqueous solution onto these surfaces, 2) removing water from the composition to achieve percent solids of between about 5% to about 20%, and 3) forming a film bound to these surfaces. The application of the aqueous solution may be accomplished by spraying using an irrigation system. Alternatively, the solution may be applied on some materials such as seeds by soaking Water may be removed by allowing the aqueous solution on the surfaces to dry under ambient conditions. Heat from the sun may expedite the drying process.

The extent of hydrophobicity of the plant environment surfaces has an influence on the adhesion strength of the superabsorbent polymer to these surfaces. A highly hydrophobic and smooth surface provides a relatively poor surface for bonding, thus an irregular and somewhat hydrophilic surface would be preferred. While it would not be practical to modify all material surfaces in the plant environment, such modification is possible with regard to some surfaces such as mulch. The scope of the present invention further comprises treating fibers present in the plant environment, such as mulch, to reduce their surface hydrophobicity to further improve binding strength of the composition onto their surfaces. A process for reducing the hydrophobicity of fiber surfaces may be accomplished by treating the fibers and fiber bundles to reduce lignin and hemicelluloses content of these fibers and is described in US U.S. Pat. No. 8,444,810. In an embodiment of the present invention the process comprises the substantially simultaneous steps of:

macerating the fibers;

removing at least a portion of the lignin from the fibers;

softening the fibers; and

swelling the fibers.

A treatment apparatus for accomplishing these steps may comprise of a closed chamber adapted for use under pressure. The chamber has a longitudinal central axis, a cylindrical enclosure and a feed opening configured with a fiber feeding device. The inner chamber walls comprise a plurality of channels. A shaft disposed along the longitudinal central axis of said chamber, is configured for rotation around the central axis. A plurality of pins is affixed and configured to protrude from the central axis in a substantially perpendicular relation to the central axis and define a tight clearance with the chamber walls.

The fibers fed into the apparatus are chemically treated in the gas phase with a gaseous mixture containing steam, ammonia and ethylenediamine at a temperature of between about 140 degrees C. and about 180 degrees C. and a pressure of about 2 kilopascals gauge. As the fibers are fed into the chamber, they are chemically softened and macerated in the tight clearance between the pins and chamber walls. The treatment partially dissolves and removes hemi-cellulose and lignin fragments from the cell wall which exposes the more hydrophilic layers of the cellulose components in the fibers.

FTIR data on the films bonded to material surfaces indicates that the superabsorbent polymer, the binder and the nutrients present in the original solution are preserved in the film. This suggests that the bonding of the components is effective.

### EXAMPLES

### Example 1

### Composition of the Aqueous Solution

Monomer: PD8081H from HB Fuller making up about 80% of the active solids neutralized with potassium hydroxide.

Binder: Ethylenediamine making up about 10% of the active solids.

Aqueous solution concentration is about 14%.

Mineral nutrients: 15 ppm Diammonium phosphate, 10 ppm Magnesium sulfate and 5 ppm Zinc carbonate.

Carbohydrate nutrient: 40 ppm of sucrose.

pH: 8.5 Viscosity: 850 cps.

Composition of film applied onto surfaces of materials in the plant environment:

Material: Plant seeds

FTIR data indicate peaks consistent with the presence of the ethylenediamine and sucrose.

### Example 2

### Composition of the Aqueous Solution

Monomer: PD8081H from HB Fuller making up about 80% of the active solids neutralized with potassium hydroxide.

Crosslinking agent: BACOTE 20® at a making up about 1% of the active solids.

Binder: Urea making up about 10% of the active solids.

Aqueous solution concentration is about 10%.

Mineral nutrients: 25 ppm Copper acetate, 15 ppm Molybdenum trioxide and 5 ppm Manganese chloride.

Carbohydrate nutrient: 40 ppm of lactose.

pH: 8.0

Viscosity: 700 cps.

Composition of Film Applied onto Surfaces of Materials in the Plant Environment:

Material: untreated mulch

Absorbency: 10 g water/gram of composition

FTIR data indicate peaks consistent with the presence of the urea, ammonium zirconium carbonate, and lactose.

### Example 3

A germination rate study was conducted by the University of Wisconsin, Green Bay using a composition embodiment consistent with the present invention. A composition comprising a superabsorbent polymer and urea was applied onto perennial rye seeds (PRG) and the germination rates were compared with those of uncoated seeds and those of seeds coated with a composition comprising a superabsorbent polymer only.

The superabsorbent polymer solution was prepared at a concentration of about 15% from PD8081H obtained from HB Fuller in a manner described in the Specification section. This is denoted as PRG/LXL in the results table below. PRG/LXL+urea denotes the superabsorbent polymer solution prepared in the same manner and containing 7% urea based on the active monomer present in the solution.

For the purpose of this example, the urea acts as both the binder and nutrient.

After germination began, seedlings were watered once a day. Humidity varied throughout the experiment. In the first 7 days, the humidity varied from about 0% to about 16% and around 40% thereafter.

The table below shows seedling counts from the day the germination started and represents averages of duplicate readings. The results indicate an increase in the germination counts for the urea containing composition relative to the composition containing only superabsorbent polymer of about 64%, 12% and 9% for 6 days, 11 days and 16 days respectively. The improvement in germination rates performance for the composition containing urea compared to the composition comprising only a superabsorbent polymer appears to be more pronounced at low humidity levels that were prevalent during the first week of the experiments. This indicates that adding a binder and nutrient makes the composition more effective in arid climates where humidity levels tend to be low.

| Sample | Day 6 | Day 11 | Day 16 |
|---|---|---|---|
| PRG Uncoated | 11.5 | 207 | 277 |
| PRG/LXL | 11 | 225 | 268 |
| PRG/LXL + Urea | 18 | 251 | 291 |

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method of coating surfaces with a composition for enhancing plant growth, said method comprising:
providing an aqueous solution containing at least one partially cross-linked superabsorbent polymer, a binder and at least one plant nutrient;
providing materials in the plant growth environment, said materials having substantially hydrophobic surfaces; and
applying the aqueous solution onto the surfaces of said materials;
wherein applying the aqueous solution onto the surfaces of said materials exposes the partially cross-linked superabsorbent polymer to sunlight and to multiple cycles of water removal from drying by sunlight and rewetting from rainfall, wherein exposure of said partially cross-linked superabsorbent polymer to ultraviolet light from the sun enhances crosslinking of said polymer and enhances a water retention capacity of said polymer from a range of about 1 gram and about 4 grams of water per gram of dry cross-linked polymer to a range of about 10 grams and about 15 grams of water per gram of dry cross-linked polymer after a third cycle of drying, wherein drying the superabsorbent polymer forms a substantially solid film on said surfaces.

18. The method of claim 17, wherein providing the aqueous solution containing at least one partially cross-linked superabsorbent monomer, a binder and at least one plant nutrient comprises:
preparing an aqueous solution containing a superabsorbent base monomer at a concentration between about 10% to about 25%, said superabsorbent base monomer being selected from the group consisting of acrylamide, methacrylic acid, acrylic acid and combinations thereof;
blending an alkaline metal with the aqueous monomer solution to raise a pH of the solution to at least 7.0, said alkali metal being selected from the group consisting of potassium, sodium, magnesium, calcium and combinations thereof;
blending in at least one mineral source nutrient component at between about 5 ppm to about 50 ppm by weight of the active monomer solution; and
blending at least one carbohydrate source nutrient component at between about 5 ppm to about 50 ppm by weight of the active monomer solution.

19. The method of claim 17, further comprising blending a binder at between about 5% to about 15% by weight of the active monomer solution with the aqueous monomer solution, said binder being selected from the group consisting of urea, pregelatinized starch, ethylenediamine and combinations thereof.

20. The method of claim 17, wherein the materials in the plant growth environment is selected from the group consisting of plant seeds, plant soil, plant roots and plant stems.

21. The method of claim 20, wherein the materials in the plant growth environment further comprise fibrous components for mulching.

22. The method of claim 17, further comprising blending a crosslinking agent with the monomer solution at between about 1% to about 2.5% by weight of the active monomer solution, said crosslinking agent comprising ammonium zirconium carbonate.
